(19) United States
(12) Patent Application Publication
(10) Pub. No.: US 2015/0303476 A1
(43) Pub. Date: Oct. 22, 2015

(54) POWER STORAGE DEVICE, AND ELECTRODE AND POROUS SHEET USED IN SAME

(71) Applicant: NITTO DENKO CORPORATION, Ibaraki-shi, Osaka (JP)

(72) Inventors: Yutaka KISHII, Ibaraki-shi (JP); Masao ABE, Ibaraki-shi (JP); Akira OTANI, Ibaraki-shi (JP); Yoshihiro UETANI, Ibaraki-shi (JP); Shigenori MORITA, Ibaraki-shi (JP)

(73) Assignee: NITTO DENKO CORPORATION, Ibaraki-shi, Osaka (JP)

(21) Appl. No.: 14/435,340

(22) PCT Filed: Nov. 12, 2013
(86) PCT No.: PCT/JP2013/080489

§ 371 Date: Apr. 13, 2015

(30) Foreign Application Priority Data
Nov. 16, 2012 (JP) 2012-252158
Mar. 26, 2013 (JP) 2013-064457

(51) Int. Cl. H01M 4/60; H01M 10/052

(52) U.S. Cl. CPC H01M 4/604; H01M 4/608; H01M 10/052; H01M 2220/30

(57) ABSTRACT

A power storage device including an electrolyte layer, and a positive electrode and a negative electrode provided, with the electrolyte layer interposed therebetween. At least one of the electrodes is a composite including at least a thiophene polymer (A) having electrical conductivity varied by ion insertion/desertion, and a polycarboxylic acid (B). The polycarboxylic acid (B) is fixed in the electrode. A high-performance power storage device having an excellent capacity density per active substance weight and excellent high-speed charge and discharge characteristics is provided.

### TECHNICAL FIELD

The present invention relates to a power storage device, and an electrode and a porous sheet for use in the same. More particularly, the present invention relates to a power storage device excellent in high-speed charge and discharge characteristics and in capacity density, and an electrode and a porous sheet for use in the same.

### BACKGROUND ART

With recent improvement and advancement of electronics technology for mobile PCs, mobile phones and personal digital assistants (PDAs), secondary batteries and the like, which can be repeatedly charged and discharged, are widely used as power storage devices for these electronic apparatuses. Increases in capacity of an electrode material and high-speed charge and discharge characteristics are desirable for electrochemical power storage devices such as these secondary batteries.

An electrode for such a power storage device contains an active substance which is capable of ion insertion/desertion. The ion insertion/desertion of the aforementioned active substance is also referred to as doping/dedoping, and the doping/dedoping amount per unit molecular structure is referred to as dope percentage (or doping percentage). A material having a higher dope percentage can provide a higher capacity battery.

From an electrochemical viewpoint, the capacity of the battery can be increased by using an electrode material having a greater ion insertion/desertion amount. In lithium secondary batteries which are attractive power storage devices, more specifically, a graphite-based negative electrode capable of lithium ion insertion/desertion is used in which about one lithium ion is inserted and deserted with respect to six carbon atoms to provide a higher capacity.

Of these lithium secondary batteries, a lithium secondary battery which has a higher energy density and, therefore, is widely used as the power storage device for the aforesaid electronic apparatuses includes a positive electrode prepared by using a lithium-containing transition metal oxide such as lithium manganate or lithium cobaltate, and a negative electrode prepared by using a carbon material capable of lithium ion insertion/desertion, the positive electrode and the negative electrode being disposed in opposed relation in an electrolytic solution.

However, the aforementioned lithium secondary battery, which generates electric energy through an electrochemical reaction, disadvantageously has a lower power density because of its lower electrochemical reaction rate. Further, the lithium secondary battery has a higher internal resistance, so that rapid discharge and rapid charge of the secondary battery are difficult. In addition, the secondary battery generally has a shorter service life, i.e., a poorer cycle characteristic, because the electrodes and the electrolytic solution are degraded due to the electrochemical reaction associated with the charge and the discharge.

There is also known a lithium secondary battery in which an electrically conductive polymer such as a polyaniline containing a dopant is used as a positive electrode active substance to cope with the aforesaid problem (see PLT1).

In general, however, the secondary battery employing the electrically conductive polymer as the positive electrode active substance is of anion migration type in which the electrically conductive polymer is doped with an anion in a charge period and dedoped with the anion in a discharge period. Where a carbon material or the like capable of lithium ion insertion/desertion is used as a negative electrode active substance, therefore, it is impossible to provide a rocking chair-type secondary battery of cation migration type in which the cation migrates between the electrodes in the charge/discharge. That is, the rocking chair-type secondary battery is advantageous in that only a smaller amount of the electrolytic solution is required, but the secondary battery employing the electrically conductive polymer as the positive electrode active substance cannot enjoy this advantage. Therefore, it is impossible to contribute to the size reduction of the power storage device.

To cope with this problem, a secondary battery of cation migration type is proposed which is substantially free from change in the ion concentration of the electrolytic solution without the need for a greater amount of the electrolytic solution, and aims at improving the capacity density per unit volume or per unit weight. This secondary battery includes a positive electrode prepared by using an electrically conductive polymer containing a polymer anion such as polyvinyl sulfonate as a dopant, and a negative electrode of metal lithium (see PLT2).

### RELATED ART DOCUMENT

### Patent Document

PTL 1: JP-A-HEI03-129679

PTL 2: JP-A-HEI01-132052

### SUMMARY

However, the secondary batteries, capacitors and the like, which employ the aforementioned proposed electrically conductive polymer, are still insufficient in performance and lower in capacity density than the lithium secondary batteries, which employ the lithium-containing transition metal oxide such as lithium manganate or lithium cobaltate for the electrodes.

The present invention has been made to solve the aforementioned problems in power storage devices such as conventional lithium secondary batteries. In particular, the present invention provides a power storage device which achieves the increase in dope percentage of a thiophene polymer that is an electrode active substance having electrical conductivity varied by ion insertion/desertion and which is excellent in charge and discharge rates and in capacity density, and an electrode and a porous sheet for use in the same.

To accomplish the aforementioned object, a first aspect of the present invention is a power storage device comprising an electrolyte layer, and a positive electrode and a negative electrode provided, with the electrolyte layer interposed therebetween, wherein at least one of the electrodes is a composite including at least a thiophene polymer (A) having electrical conductivity varied by ion insertion/desertion, and a polycarboxylic acid (B), and wherein the polycarboxylic acid (B) is fixed in the electrode.

Also, a second aspect is an electrode for a power storage device, the electrode being a composite including at least a thiophene polymer (A) having electrical conductivity varied by ion insertion/desertion, and a polycarboxylic acid (B), wherein the polycarboxylic acid (B) is fixed in the electrode.

Further, a third aspect is a porous sheet for a power storage device electrode, comprising a composite including at least a thiophene polymer (A) having electrical conductivity varied by ion insertion/desertion, and a polycarboxylic acid (B), wherein the polycarboxylic acid (B) is fixed in the electrode.

The present inventors have diligently made studies to obtain a power storage device excellent in high-speed charge and discharge characteristics and in capacity density. In the course of the studies, the present inventors have directed attention toward combining the thiophene polymer (A) having electrical conductivity varied by ion insertion/desertion and the polycarboxylic acid (B) together, and have made further studies about this. As a result, the present inventors have found that mixing at least the two materials, i.e. the thiophene polymer (A) and the polycarboxylic acid (B), significantly improves the characteristics of the power storage device, contrary to expectations.

In this manner, the power storage device comprises an electrolyte layer, and a positive electrode and a negative electrode provided, with the electrolyte layer interposed therebetween, wherein at least one of the electrodes is a composite including at least a thiophene polymer (A) having electrical conductivity varied by ion insertion/desertion, and a polycarboxylic acid (B), and wherein the polycarboxylic acid (B) is fixed in the electrode. This provides a high-performance power storage device having an excellent capacity density per active substance weight and excellent high-speed charge and discharge characteristics. The active substance refers to the thiophene polymer (A) having an oxidation/reduction function.

Also, the electrode for a power storage device is a composite including at least the thiophene polymer (A) and the polycarboxylic acid (B), wherein the polycarboxylic acid (B) is fixed in the electrode. Therefore, the power storage device employing this electrode is excellent in charge and discharge characteristics and in capacity density.

Further, the porous sheet for a power storage device electrode comprises a composite including at least the thiophene polymer (A) and the polycarboxylic acid (B), wherein the polycarboxylic acid (B) is fixed in the electrode. Therefore, the power storage device employing this porous sheet is excellent in charge and discharge characteristics and in capacity density.

### BRIEF DESCRIPTION OF DRAWINGS

FIG. 1 is a sectional view showing a structure of electrodes for a power storage device.

FIG. 2 is a graph showing a correlation between a capacity density and an electrolytic solution weight/poly (3,4-ethylenedioxythiophene) [PEDOT] weight for batteries having varied proportions between the electrolytic solution weight (mg) and the poly (3,4-ethylenedioxythiophene) [PEDOT].

FIG. 3 is a graph showing a correlation between a capacity density and an electrolytic solution weight/polythiophene weight for batteries having varied proportions between the electrolytic solution weight (mg) and the polythiophene.

### DESCRIPTION OF EMBODIMENTS

An embodiment of the present invention will hereinafter be described in detail by way of example but not by way of limitation.

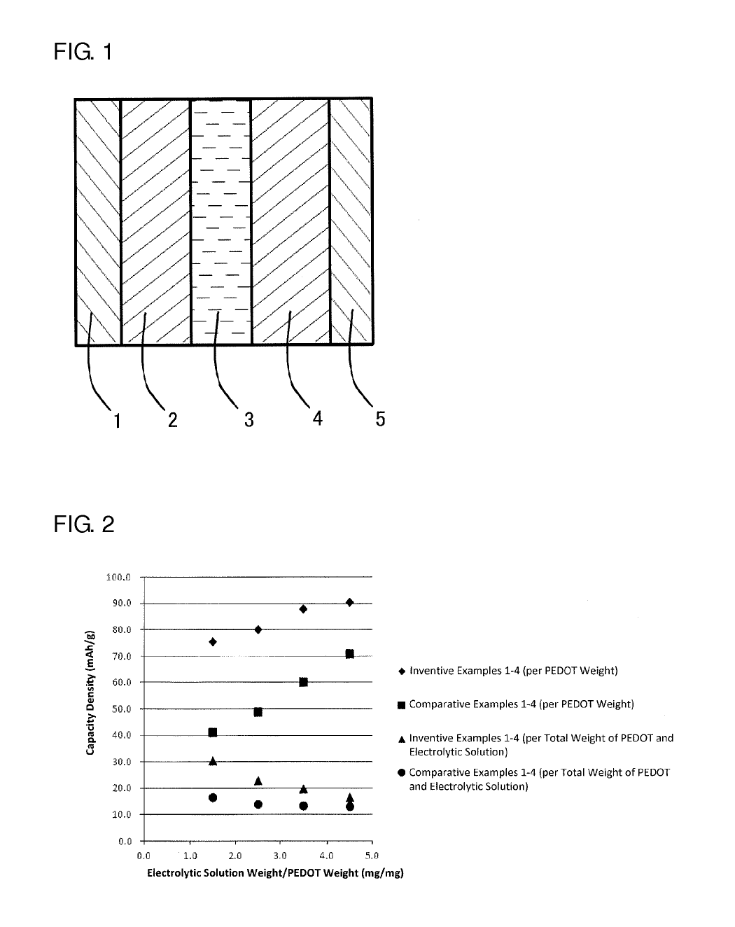

As shown in FIG. 1, a power storage device according to the present invention is a power storage device having an electrolyte layer 3, and a positive electrode 2 and a negative electrode 4 provided, with the electrolyte layer 3 interposed therebetween. At least one of the electrodes is a composite including at least a thiophene polymer (A) having electrical conductivity varied by ion insertion/desertion, and a polycarboxylic acid (B). The polycarboxylic acid (B) is fixed in the electrode.

The most striking characteristic of the present invention is the provision of an electrode comprised of a composite including the aforementioned components (A) and (B). The materials employed therefor and the like will be described step by step.

<Thiophene Polymer (A)>

The aforementioned thiophene polymer (A) is a polymer (referred to hereinafter as an “electrode active substance” in some cases) having electrical conductivity varied by ion insertion/desertion, and is an electrically conductive polymer material such as polythiophenes and substitution products of these polymers. Specific examples include poly(3,4-ethylenedioxythiophene) (hereinafter abbreviated as “PEDOT” in some cases), poly(3,4-propylenedioxythiophene), poly[3,4-(2′,2′-diethylpropylene)dioxythiophene], poly[3,4-(2,2-diethylpropylenedioxyl)thiophene], poly(3-alkylthiophenes) such as poly(3-methylthiophene) and poly(3-ethylthiophene), poly[3-(4-octylphenyl)thiophene], and poly[hydroxymethyl(3,4-ethylenedioxythiophene)]. In particular, PEDOT is especially preferably used from the viewpoints of its high electrochemical capacity and good heat-resisting properties.

The aforementioned thiophene polymer (A) is better in heat-resisting properties than other electrically conductive polymers, and is a material capable of achieving the increase in voltage as battery characteristics when used as a positive electrode. Also, while other electrically conductive polymers have performance of what is called a P type, the thiophene polymer (A) can be used for both a P type and an N type. That is, the thiophene polymer (A) has a characteristic of being usable for both a positive electrode and a negative electrode of a battery.

In a charge period or a discharge period, the aforementioned thiophene polymer (A) may be either in a doped state (state of charge) or in a reduced dedoped state (state of discharge).

The electrically conductive polymer material such as the aforementioned thiophene polymer (A) is normally in a doped state (ion-inserted state) as it is. On the other hand, when the aforementioned thiophene polymer (A) is not in the doped state (state of charge), the execution of a doping process brings the thiophene polymer (A) into the doped state. Specific examples of methods for the doping process include a method of mixing a dopant containing doping atoms into a starting material (for example, a thiophene-based monomer component), and a method of causing a product (for example, a polythiophene-based polymer component) to react with a dopant.

As stated earlier, the ion insertion/desertion of the aforementioned thiophene polymer (A) is also referred to as what is called doping/dedoping, and the doping amount per unit molecular structure is referred to as a dope percentage. A material having a higher dope percentage can provide a higher capacity battery.

The dope percentage as used in the present invention means the doping/dedoping amount per unit molecular structure of the thiophene polymer (A) which is an electrode active substance, as mentioned above.

For example, the dope percentage of the thiophene polymer (A) is 0.5 for PEDOT. A higher dope percentage can provide a higher capacity battery. For example, the electrical conductivity of PEDOT is on the order of 10¹ to 10³ S/cm in the doped state, and is 10⁻⁵ to 10⁰ S/cm in the dedoped state.

For the reduced dedoped state (state of discharge) of the aforementioned thiophene polymer (A) in the early stage, it is customary to bring the thiophene polymer (A) directly into the reduced dedoped state, but the thiophene polymer (A) may be reduced after being brought into the dedoped state. The dedoped state is obtained by neutralizing (performing an alkali treatment on) a dopant of the thiophene polymer (A). For example, the thiophene polymer (A) in the dedoped state is obtained by stirring in a solution which neutralizes the dopant of the aforementioned thiophene polymer (A) and thereafter washing and filtering. A specific example of the method of dedoping the thiophene polymer containing hydrochloric acid as a dopant includes stirring in a sodium hydroxide aqueous solution to accomplish neutralization.

Next, the reduced dedoped state is obtained by reducing the thiophene polymer (A) in the dedoped state. For example, the thiophene polymer (A) in the reduced dedoped state is obtained by stirring in a solution which reduces the thiophene polymer (A) in the dedoped state and thereafter washing and filtering. A specific example of the method of reducing the thiophene polymer (A) in the dedoped state includes stirring the thiophene polymer in the dedoped state in a phenylhydrazine methanol aqueous solution (reduction treatment).

The power storage device according to the present invention is generally formed using an electrode made of a material containing the aforementioned thiophene polymer (A) and a polycarboxylic acid (B) to be described next. This electrode is in the form of a porous sheet and the like by us ing at least the aforementioned thiophene polymer (A) and the polycarboxylic acid (B).

<Polycarboxylic Acid (B)>

Examples of the aforementioned polycarboxylic acid (B) include polymers, carboxylic acid substituted compounds each having a relatively great molecular weight, and carboxylic acid substituted compounds each having a lower solubility in an electrolytic solution. More specifically, a compound having a carboxyl group in its molecule is preferably used. In particular, the polycarboxylic acid (B) that is a polymer has the advantage of being able to function also as a binder.

Examples of the aforementioned polycarboxylic acid (B) include polyacrylic acid, polymethacrylic acid, polyvinylbenzoic acid, polyallylbenzoic acid, polymethallylbenzoic acid, polymaleic acid, polyfumaric acid, polyglutamic acid and polyasparaginic acid. Inparticular, polyacrylic acid and polymaleic acid are especially preferably used. These polycarboxylic acids may be used either alone or in combination.

When the aforementioned polycarboxylic acid (B) is used together with the thiophene polymer (A) in the power storage device according to the present invention, this polycarboxylic acid (B) functions as a binder and also as a dopant to provide a rocking chair-type mechanism. This seems to be involved in improvements in the characteristic properties of the power storage device according to the present invention.

The aforementioned polycarboxylic acid (B) may be a polycarboxylic acid of lithium-exchanged type prepared by lithium-exchanging a carboxylic acid of a carboxyl-containing compound in its molecule. The lithium exchange percentage is especially preferably 100%, but may be lower (preferably 40% to 100%) according to the conditions.

The aforementioned polycarboxylic acid (B) is generally used in an amount of 1 to 100 parts by weight, preferably 2 to 70 parts by weight, most preferably 5 to 40 parts by weight, based on 100 parts by weight of the thiophene polymer (A). If the amount of the polycarboxylic acid (B) is excessively small with respect to the aforementioned thiophene polymer (A), it will be difficult to provide a power storage device having a higher capacity density. If the amount of the polycarboxylic acid (B) is excessively great with respect to the thiophene polymer (A), on the other hand, it will be also difficult to provide a power storage device having a higher capacity density.

Further, a binder other than the aforementioned polycarboxylic acid (B), an electrically conductive agent and the like may be appropriately mixed as electrode forming materials, when required, together with the aforementioned thiophene polymer (A) and the polycarboxylic acid (B).

The aforementioned electrically conductive agent is only required to be an electrically conductive material free from change in its properties depending on a potential applied during the discharge of the power storage device. Examples of the electrically conductive agent include electrically conductive carbon materials and metal materials. In particular, electrically conductive carbon blacks such as acetylene black and Ketjen black, and fibrous carbon materials such as carbon fibers and carbon nanotubes are preferably used. Electrically conductive carbon blacks are especially preferable.

The aforementioned electrically conductive agent is preferably 1 to 30 parts by weight, more preferably 4 to 20 parts by weight, especially preferably 8 to 18 parts by weight, based on 100 parts by weight of the electrically conductive polymer. If the amount of the electrically conductive agent to be mixed is in this range, the active substance is prepared without anomalies in its shape and characteristics to effectively improve rate characteristics.

An example of the binder other than the aforementioned polycarboxylic acid (B) includes vinylidene fluoride.

<Electrode>

An electrode for the power storage device of the present invention is made of a composite including at least the aforementioned thiophene polymer (A) and the polycarboxylic acid (B), and is preferably in the form of a porous sheet. In general, the thickness of the electrode is preferably 1 to 1000 μm, and more preferably 10 to 700 μm. The electrode for the power storage device of the present invention is characterized by being usable for both a positive electrode and a negative electrode of a battery, as mentioned earlier. An instance where the electrode for the power storage device of the present invention is used as a positive electrode will be described hereinafter.

The thickness of the aforementioned electrode is obtained by measuring by means of a standard type dial gage (available from Ozaki Mfg. Co., Ltd.) which is a flat plate including a distal end portion having a diameter of 5 mm, and then averaging the values measured at ten points on a surface of the electrode. When the positive electrode 2 and the electrolyte layer 3 (both of which are porous layers) are provided on a current collector 1 and combined with the current collector 1, the thickness of the electrode is obtained by measuring the thickness of the combined product in the aforementioned manner, taking the average of the measurement values, and then subtracting the thickness of the current collector 1.

The electrode for the power storage device of the present invention is produced, for example, in the following manner. The aforementioned polycarboxylic acid (B) is dissolved in water, so that an aqueous solution is prepared. The aforementioned thiophene polymer (A) and, as required, the electrically conductive agent and a binder other than the polycarboxylic acid (B) are appropriately added to the aqueous solution, and sufficiently dispersed, so that a paste is prepared. The paste is applied onto a current collector, and water is evaporated. This provides a sheet electrode (electrode) in the form of a composite (porous sheet) having a mixture layer containing the thiophene polymer (A), the polycarboxylic acid (B) and, as required, the electrically conductive agent and the binder other than the polycarboxylic acid (B) on the current collector.

In the electrode formed in the aforementioned manner, the polycarboxylic acid (B) is present as a mixture layer with the thiophene polymer (A), and is thus fixed in the electrode. The polycarboxylic acid (B) fixedly disposed near the thiophene polymer (A) in this manner is used also for charge compensation during the oxidation/reduction of the thiophene polymer (A).

Thus, the power storage device according to the present invention has a rocking chair-type ion migration mechanism, as mentioned earlier, to require small quantities of anions in the electrolytic solution which serve as a dopant. This results in the power storage device capable of giving rise to good characteristics even when the amount of usage of the electrolytic solution is small.

An apparent volume of the aforementioned electrode as used in the present invention refers to “electrode area×electrode thickness of electrode”, and specifically is the sum total of the volume of the substance of the electrode, the volume of voids in the electrode and the volume of the space of uneven portions on the surface of the electrode.

A void percentage (%) of the electrode is calculated by {(apparent volume of electrode−absolute volume of electrode)/apparent volume of electrode}×100. The void percentage is preferably 50% to 95%, and more preferably 60% to 90%.

The absolute volume of the electrode as used in the present invention refers to the “volume of electrode constituent materials” except the current collector of aluminum foil and the like. Specifically, the absolute volume of the electrode is determined by calculating the mean density of all electrode constituent materials with the use of the constituent weight proportion of a positive electrode constituent material and the value of the true density of each constituent material and then dividing the sum total of the weights of the electrode constituent materials by the mean density.

Examples of the true density (absolute specific gravity) of each of the aforementioned constituent materials are as follows. The true density of PEDOT as an example of the thiophene polymer (A) as used herein is 1.69, and the true density of polyacrylic acid as an example of the polycarboxylic acid (B) as used herein is 1.2.

<Electrolyte Layer>

The electrolyte layer for use in the power storage device according to the present invention is formed from an electrolyte. For example, a sheet including a separator impregnated with an electrolytic solution or a sheet made of a solid electrolyte is preferably used. The sheet made of the solid electrolyte per se functions as a separator.

The aforementioned electrolyte includes a solute and, as required, a solvent and additives. Preferred examples of the solute include compounds prepared by combining a metal ion such as a lithium ion with a proper counter ion, a sulfonate ion, a perchlorate ion, a tetrafluoroborate ion, a hexafluorophosphate ion, a hexafluoroarsenic ion, a bis(trifluoromethanesulfonyl)imide ion, a bis(pentafluoroethanesulfonyl)imide ion or a halide ion. Accordingly, specific examples of the electrolyte include LiCF₃SO₃, LiClO₄, LiBF₄, LiPF₆, LiAsF₆, LiN(SO₂CF₃)₂, LiN(SO₂C₂F₅)₂ and LiCl.

Examples of the aforementioned solvent used as required include nonaqueous solvents, i.e., organic solvents, such as carbonates, nitriles, amides and ethers, at least one of which is used. Specific examples of the organic solvents include ethylene carbonate, propylene carbonate, butylene carbonates, dimethyl carbonate, diethyl carbonate, ethyl methyl carbonate, acetonitrile, propionitrile, N,N′-dimethylacetamide, N-methyl-2-pyrrolidone, dimethoxyethane, diethoxyethane and γ-butyrolactone, which may be used either alone or in combination. A solution prepared by dissolving the solute in the solvent may be referred to as an “electrolytic solution” in some cases.

In the present invention, the separator can be used in a variety of forms as described above. The separator may be an insulative porous sheet which is capable of preventing an electrical short circuit between the positive electrode and the negative electrode disposed in opposed relation with the separator interposed therebetween, which is electrochemically stable and which has a higher ionic permeability and a certain mechanical strength. Therefore, exemplary materials for the separator include paper, nonwoven fabric, porous sheets having porosity and made of a resin such as polypropylene, polyethylene or polyimide, which may be used either alone or in combination.

<Negative Electrode>

The negative electrode for the power storage device of the present invention is produced using a negative electrode active substance. Examples of the negative electrode active substance include metal lithium, carbon materials and transition metal oxides capable of insertion and desertion of lithium ions in oxidation and reduction, silicon and tin. The term “use” as used in the present invention is to be interpreted as including, meaning that the forming material is used in combination with a second forming material in addition to meaning that only the forming material is used. The proportion of the second forming material to be used is generally less than 50% by weight of the forming material.

<Power Storage Device>

The power storage device will be described using the aforementioned materials with reference to FIG. 1. The battery is preferably assembled in a glove box in an inert gas atmosphere such as an ultrapure argon gas atmosphere.

With reference to FIG. 1, exemplary materials of the current collectors (1 and 5 in FIG. 1) for the positive electrode 2 and the negative electrode 4 include metal foils and meshes such as of nickel, aluminum, stainless steel and copper, as required.

The power storage device according to the present invention has an excellent capacity density which is generally not less than 10 mAh/g and preferably not less than 50 mAh/g per weight of the thiophene polymer (A).

The reason why the power storage device according to the present invention has such a high capacity is as follows. In the electrode formed in the aforementioned manner, the polycarboxylic acid (B) is disposed as a mixture layer with the thiophene polymer (A), and is thus fixed in the electrode, as mentioned above. The polycarboxylic acid (B) fixedly disposed near the thiophene polymer (A) in this manner is used also for charge compensation during the oxidation/reduction of the thiophene polymer (A). Also, the ionic environment of the polycarboxylic acid (B) facilitates the migration of ions inserted/deserted from the thiophene polymer (A). For this and other reasons, the dope percentage of the thiophene polymer (A) is improved. Further, the provision of the rocking chair-type ion migration mechanism requires small quantities of anions in the electrolytic solution which serve as a dopant. As a result, it is inferred that the power storage device capable of giving rise to good characteristics (high capacity density and the like) even when the amount of usage of the electrolytic solution is small is provided.

### EXAMPLES

Inventive examples will hereinafter be described in conjunction with comparative examples. However, the present invention is not limited to these examples.

The following components were prepared before the production of power storage devices according to the inventive examples and the comparative examples.

[Preparation of Thiophene Polymer (A)]

Electrically conductive PEDOT powder containing iron trichloride as a dopant was prepared in the following manner as a thiophene polymer (A) which was an electrode active substance.

(Electrically Conductive PEDOT Powder)

In a nitrogen atmosphere, 73.9 g of iron trichloride was dissolved in 900 g of acetonitrile in a three-necked flask. Thereafter, the flask was immersed in an ice bath containing sodium chloride, and was held at 0° C. or lower.

Next, a solution prepared by dissolving 26.0 g of 3,4-ethylenedioxythiophene (available from Junsei Chemical Co., Ltd.) in 20 g of acetonitrile was dripped into the solution comprised of iron trichloride and acetonitrile over 2 hours. After the completion of the dripping, the solution was continuously stirred at room temperature (25° C.) for 30 minutes. This caused a reaction to thereby generate PEDOT.

After the reaction, the solution was filtered, and solid content was washed with a large amount of water and acetone and vacuum-dried at room temperature (25° C.). This provided 25 g of electrically conductive PEDOT in a doped state containing iron trichloride as a dopant (referred to simply as “electrically conductive PEDOT” hereinafter). This electrically conductive PEDOT powder was black powder.

(Electrical Conductivity of Electrically Conductive PEDOT Powder)

After 150 mg of the electrically conductive PEDOT powder was milled in an agate mortar, the resulting powder was compacted into a disk-shaped formed film of electrically conductive PEDOT powder having a thickness of 720 μm in vacuum at a pressure of 75 MPa for 10 minutes by means of a KBr tablet forming machine for infrared spectrum measurement. The formed film had an electrical conductivity of 30.5 S/cm as measured by Van der Pauw four-terminal electrical conductivity measurement method.

(PEDOT Powder in Dedoped State)

Next, the electrically conductive PEDOT powder in the doped state was put in a 2 N sodium hydroxide aqueous solution, and stirred for 30 minutes. Thus, the electrically conductive PEDOT powder was dedoped with the iron trichloride serving as a dopant through a neutralization reaction. The dedoped PEDOT was washed with water until the filtrate became neutral. Then, the dedoped PEDOT was washed in acetone with stirring, and suction-filtered with the use of a Buchner funnel and a suction bottle, so that dedoped PEDOT powder was obtained on No. 2 filter paper (available from ADVANTEC Corporation). This powder was dried in vacuum at room temperature (25° C.) for 10 hours, whereby black PEDOT powder in a dedoped state was provided.

(PEDOT Powder in Reduced Dedoped State)

Next, the PEDOT power in the dedoped state was put in a phenylhydrazine methanol aqueous solution, and reduced for 30 minutes with stirring. After the reaction, the resulting PEDOT powder was washed with methanol and with acetone in the order named, filtered, and dried in vacuum at room temperature (25° C.). Thus, PEDOT powder in a reduced dedoped state was provided. The yield was 15.5 g.

(Electrical Conductivity of PEDOT Powder in Reduced Dedoped State)

After 150 mg of the PEDOT powder in the reduced dedoped state was milled in an agate mortar, the resulting powder was compacted into a disk-shaped formed film of electrically conductive PEDOT powder in the reduced dedoped state having a thickness of 720 μm in vacuum at a pressure of 75 MPa for 10 minutes by means of a KBr tablet forming machine for infrared spectrum measurement. The formed film had an electrical conductivity of 1.8×10¹ S/cm as measured by Van der Pauw four-terminal electrical conductivity measurement method.

[Preparation of Polycarboxylic Acid (B)]

A polycarboxylic acid (B) serving as an anionic material in which an anion was compensated for by a counter ion was prepared in the following manner. Using polyacrylic acid (available from Wako Pure Chemical Industries, Ltd., and having a weight-average molecular weight of 800,000), lithium hydroxide in an amount of 1/2 equivalent of a carboxylic acid was added in an aqueous solution. Thus, 4.5% by weight of a poly(acrylic acid-lithium) aqueous solution (having a molecular weight of 800,000) which was a homogeneous viscous polyacrylic acid aqueous solution was prepared as the polycarboxylic acid (B). In other words, the polyacrylic acid became a polyacrylic acid-lithium polyacrylate composite solution in which approximately 50% of a carboxyl group was changed to a lithium salt (lithium conversion ratio of 0.5).

[Preparation of Negative Electrode Material]

Metal lithium foil (available from Honjo Metal Co., Ltd.) having a thickness of 50 μm was prepared.

[Preparation of Electrolytic Solution]

An ethylene carbonate/dimethyl carbonate solution containing lithium tetrafluoroborate (LiBF₄) at a concentration of 1 mol/dm³ (available from Kishida Chemical Co., Ltd.) was prepared.

[Preparation of Separator]

A nonwoven fabric (TF40-50 available from Hohsen Corporation and having a void percentage of 55%) was prepared.

### Inventive Example 1

### Formation of Electrode (Positive Electrode) Using (A) and (B)

[Production of Positive Electrode Sheet Containing PEDOT Powder]

After 4.00 g of the PEDOT powder was mixed with 0.53 g of electrically conductive carbon black powder (DENKA BLACK available from Denki Kagaku Kogyo Kabushiki Kaisha), 19 g of the 4.5% by weight poly(acrylic acid-lithium) aqueous solution (having a lithium conversion ratio of 0.5 and a molecular weight of 800,000) and 16.0 g of distilled water were added to the resulting mixture. The resulting mixture was kneaded and mixed by a spatula, and ultrasonically treated for 5 minutes by an ultrasonic homogenizer. Then, high-speed stirring was performed on the mixture at a peripheral speed of 20 m/min for 30 seconds by means of a thin-film spin system high-speed mixer (FILMIX MODEL 40-40 available from Primix Corporation) to provide a fluid paste. The paste was defoamed for 3 minutes by means of a planetary centrifugal mixer (THINKY MIXER available from Thinky Corporation).

The defoamed paste was applied onto an etched aluminum foil for an electric double layer capacitor (30CB available from Hohsen Corporation) with the use of a desktop automatic coater (available from Tester Sangyo Co., Ltd.) while a coating rate was held at 10 mm/sec by a doctor blade applicator equipped with a micrometer. Next, the resulting coating was allowed to stand at room temperature (25° C.) for 45 minutes, and then dried on a hot plate at a temperature of 100° C. for 1 hour. Thus, a composite sheet was provided.

In this composite sheet, a positive electrode active substance layer comprised of the PEDOT powder, the electrically conductive carbon black powder and the polyacrylic acid had a thickness of 295 μm and a void percentage of 87.7%.

<Production of Secondary Battery>

First, the composite sheet was punched out in the form of a disk by means of a punching tool equipped with a punching blade having a diameter of 15.95 mm to provide a positive electrode sheet. Metal lithium foil [coin type metal lithium (having a thickness of 50 μm) available from Honjo Metal Co., Ltd.] was used as a negative electrode. A nonwoven fabric (TF40-50 available from Hohsen Corporation) having a void percentage of 55% was used as a separator. The positive electrode sheet, the negative electrode and the separator were assembled to a stainless steel HS cell (available from Hohsen Corporation) for a nonaqueous electrolytic solution secondary battery experiment, so that a lithium secondary battery was produced. Before being assembled to the HS cell, the positive electrode sheet and the separator were dried in vacuum at 100° C. for 5 hours by a vacuum dryer. An ethylene carbonate/dimethyl carbonate solution containing lithium tetrafluoroborate (LiBF₄) at a concentration of 1 mol/dm³ (available from Kishida Chemical Co., Ltd.) was used as the electrolytic solution. The weight (mg) of the electrolytic solution was 4.5 times the weight (mg) of the PEDOT. That is, electrolytic solution weight (mg)/PEDOT weight (mg)=4.5 (mg/mg).

The lithium secondary battery was assembled in a glove box having a dew point of −100° C. in an ultrapure argon gas atmosphere.

(Battery Performance of Positive Electrode Sheet Containing PEDOT Powder)

Assuming that the dope percentage is 0.5, the weight capacity density of the PEDOT is 94.3 mAh/g. A full capacity (mAh) was calculated by multiplying the amount of PEDOT contained per electrode unit area by 94.3 mAh/g, and the rate at which this capacity was charged for 1 hour was defined as 1 C charge. It was assumed that an imaginary capacity was 188.54 (mAh/g) when the PEDOT had a dope percentage of 1.0.

The battery was charged to a voltage of 3.8 V at a 0.05 C-equivalent current value. After the 3.8 V was reached, the charge process is changed to a constant-potential charge process. After the charging, the battery was allowed to stand for 30 minutes. Thereafter, the battery was discharged at a 0.05 C-equivalent current value until the voltage reached 2 V.

When the battery discharge capacity using the aforementioned electrodes was converted per PEDOT weight, the capacity density was 90.5 mAh/g. Further, when the battery discharge capacity using the aforementioned electrodes was converted per total weight of the PEDOT weight and the weight of the used electrolytic solution, the capacity density was 16.5 mAh/g.

### Inventive Example 2

A battery cell (lithium secondary battery) was produced in substantially the same manner as in Inventive Example 1 except that the weight (mg) of the electrolytic solution was 3.5 times the weight (mg) of the PEDOT. Then, evaluations were made in the same manner as in Inventive Example 1. The results are shown below in Table 1.

### Inventive Example 3

A battery cell (lithium secondary battery) was produced in substantially the same manner as in Inventive Example 1 except that the weight (mg) of the electrolytic solution was 2.5 times the weight (mg) of the PEDOT. Then, evaluations were made in the same manner as in Inventive Example 1. The results are shown below in Table 1.

### Inventive Example 4

A battery cell (lithium secondary battery) was produced in substantially the same manner as in Inventive Example 1 except that the weight (mg) of the electrolytic solution was 1.5 times the weight (mg) of the PEDOT. Then, evaluations were made in the same manner as in Inventive Example 1. The results are shown below in Table 1.

### Comparative Example 1

A battery cell (lithium secondary battery) was produced in substantially the same manner as in Inventive Example 1 except that a solution mixture of 0.31 g of a styrene-butadiene rubber (SBR) emulsion (TRD2001 available from JSR Corporation and having an SBR content of 48% by weight) and 1.76 g of a poly (N-vinylpyrrolidone) aqueous solution (K-90W available from Nippon Shokubai Co., Ltd. and having a content of 19.8% by weight) was used instead of 19 g of the 4.5% by weight polyacrylic acid aqueous solution. In this composite sheet, a positive electrode active substance layer had a thickness of 250 μm and a void percent age of 55%. Then, evaluations were made in the same manner as in Inventive Example 1. The results are shown below in Table 1.

### Comparative Example 2

A battery cell (lithium secondary battery) was produced in substantially the same manner as in Comparative Example 1 except that the weight (mg) of the electrolytic solution was 3.5 times the weight (mg) of the PEDOT. Then, evaluations were made in the same manner as in Inventive Example 1. The results are shown below in Table 1.

### Comparative Example 3

A battery cell (lithium secondary battery) was produced in substantially the same manner as in Comparative Example 1 except that the weight (mg) of the electrolytic solution was 2.5 times the weight (mg) of the PEDOT. Then, evaluations were made in the same manner as in Inventive Example 1. The results are shown below in Table 1.

### Comparative Example 4

A battery cell (lithium secondary battery) was produced in substantially the same manner as in Comparative Example 1 except that the weight (mg) of the electrolytic solution was 1.5 times the weight (mg) of the PEDOT. Then, evaluations were made in the same manner as in Inventive Example 1. The results are shown below in Table 1.

TABLE 1

| | | | | Capacity |
|---|---|---|---|---|
| | | | | density per |
| | | Ratio of | Capacity | total weight of |
| | | electrolytic | density | PEDOT and |
| | Use of poly- | solution | per PEDOT | electrolytic |
| | acrylic | weight/PEDOT | weight | solution |
| | acid (B) | weight (mg/mg) | (mAh/g) | (mAh/g) |
| Inv. | Yes | 4.5 | 90.5 | 16.5 |
| Ex. 1 | | | | |
| Inv. | Yes | 3.5 | 88.0 | 19.6 |
| Ex. 2 | | | | |
| Inv. | Yes | 2.5 | 80.0 | 22.9 |
| Ex. 3 | | | | |
| Inv. | Yes | 1.5 | 75.6 | 30.2 |
| Ex. 4 | | | | |
| Comp. | No | 4.5 | 70.8 | 12.9 |
| Ex. 1 | | | | |
| Comp. | No | 3.5 | 60.3 | 13.4 |
| Ex. 2 | | | | |
| Comp. | No | 2.5 | 49.0 | 14.0 |
| Ex. 3 | | | | |
| Comp. | No | 1.5 | 41.2 | 16.5 |
| Ex. 4 | | | | |

* An SBR/polyvinylpyrrolidone-based binder was used instead of the polyacrylic acid (B) in Comparative Examples 1 to 4.

[Preparation of Thiophene Polymer (A)]

Electrical conductivity polythiophene powder containing iron trichloride as a dopant was prepared in the following manner as the thiophene polymer (A) which was the electrode active substance.

(Electrically Conductive Polythiophene Powder)

In a nitrogen atmosphere, 28.8 g of iron trichloride was added together with 100 ml of chloroform into a three-necked flask. Thereafter, the flask was immersed in an ice bath containing sodium chloride, and was held at 0° C. or lower.

Next, a solution was prepared by dissolving 5.0 g of thiophene (available from Sigma-Aldrich Co.,) in 50 g of chloroform. The resulting solution was dripped into the solution comprised of iron trichloride and chloroform over 2 hours. After the completion of the dripping, the solution was continuously stirred at room temperature (25° C.) for 12 hours. This caused a reaction to thereby generate polythiophene.

After the reaction, the solution was filtered. Thereafter, the solution was developed in methanol while being stirred. Thereafter, the solution was filtered again. After this operation was repeated five times, a vacuum drying process was performed on the resulting polythiophene powder at room temperature (25° C.) overnight. The resulting polythiophene powder was brown, and the yield was 6.3 g.

(Electrical Conductivity of Electrically Conductive Polythiophene Powder)

After 150 mg of the electrically conductive polythiophene powder was milled in an agate mortar, the resulting powder was compacted into a disk-shaped formed film of electrically conductive polythiophene powder having a thickness of 720 μm in vacuum at a pressure of 75 MPa for 10 minutes by means of a KBr tablet forming machine for infrared spectrum measurement. The formed film had an electrical conductivity of 10.8 S/cm as measured by Van der Pauw four-terminal electrical conductivity measurement method.

(Polythiophene Powder in Reduced Dedoped State)

Next, the electrically conductive polythiophene powder in the doped state was stirred overnight in an aqueous solution containing hydrazine monohydrate in an amount of six equivalents of a monomeric unit of polythiophene. After the reaction solution was filtered, the solution was developed in methanol while being stirred. Thereafter, the solution was filtered again. After this operation was repeated four times, a vacuum drying process was performed on a solid content at room temperature (25° C.) overnight. The resulting polythiophene powder in the reduced dedoped state was brown, and the yield was 4.9 g.

(Electrical Conductivity of Polythiophene Powder in Reduced Dedoped State)

After 150 mg of the polythiophene powder in the reduced dedoped state was milled in an agate mortar, the resulting powder was compacted into a disk-shaped formed film of polythiophene powder in the reduced dedoped state having a thickness of 720 μm in vacuum at a pressure of 75 MPa for 10 minutes by means of a KBr tablet forming machine for infrared spectrum measurement. The formed film had an electrical conductivity of 5.8×10⁻² S/cm as measured by Van der Pauw four-terminal electrical conductivity measurement method.

[Preparation of Polycarboxylic Acid (B)]

The same material as in Inventive Example 1 was used.

[Preparation of Negative Electrode Material]

The same material as in Inventive Example 1 was used.

[Preparation of Electrolytic Solution]

The same material as in Inventive Example 1 was used.

[Preparation of Separator]

The same material as in Inventive Example 1 was used.

### Inventive Example 5

### Formation of Electrode (Positive Electrode) Using (A) and (B)

[Production of Positive Electrode Sheet Containing Polythiophene Powder]

After 1.00 g of the polythiophene powder was mixed with 0.137 g of electrically conductive carbon black powder (DENKA BLACK available from Denki Kagaku Kogyo Kabushiki Kaisha), 8.11 g of the 4.5% by weight poly(acrylic acid-lithium) aqueous solution (having a lithium conversion ratio of 0.5 and a molecular weight of 800,000) was added to the resulting mixture. The resulting mixture was kneaded well by a spatula, and thereafter kneaded and mixed in an agate mortar.

Then, a composite sheet serving as a positive electrode was provided in the same manner as in Inventive Example 1 described above. In this composite sheet, a positive electrode active substance layer comprised of the polythiophene powder, the electrically conductive carbon black powder and the polyacrylic acid had a thickness of 205 μm and a void percentage of 67.5%.

<Production of Secondary Battery>

Further, a battery cell (lithium secondary battery) was produced in the same manner as in Inventive Example 1 described above.

(Battery Performance of Positive Electrode Sheet Containing Polythiophene Powder)

Assuming that the dope percentage is 0.1, the weight capacity density of the polythiophene is 16.3 mAh/g. A full capacity (mAh) was calculated by multiplying the amount of polythiophene contained per electrode unit area by 16.3 mAh/g, and the rate at which this capacity was charged for 1 hour was defined as 1 C charge. It was assumed that an imaginary capacity was 163 (mAh/g) when the polythiophene had a dope percentage of 1.0.

The battery was charged to a voltage of 3.8 V at a 0.05 C-equivalent current value. After the 3.8 V was reached, the charge process is changed to a constant-potential charge process. After the charging, the battery was allowed to stand for 30 minutes. Thereafter, the battery was discharged at a 0.05 C-equivalent current value until the voltage reached 2 V. This operation was repeated five times. Subsequently, an upper-limit voltage was set at 4.0 V, and the same charge and discharge operation was repeated five times. Further, the upper-limit voltage was set at 4.2 V, and the charge and discharge operation was repeated five times. An average discharge voltage was 3.7 V which was high.

When the battery discharge capacity using the aforementioned electrodes for the fifth 4.2-V charge and discharge operation was converted per polythiophene weight, the capacity density was 25.0 mAh/g. Further, when the battery discharge capacity using the aforementioned electrodes for the fifth 4.2-V charge and discharge operation was converted per total weight of the polythiophene weight and the weight of the used electrolytic solution, the capacity density was 4.5 mAh/g.

### Inventive Example 6

A battery cell (lithium secondary battery) was produced in substantially the same manner as in Inventive Example 5 except that the weight (mg) of the electrolytic solution was 3.5 times the weight (mg) of the polythiophene. Then, evaluations were made in the same manner as in Inventive Example 5. The results are shown below in Table 2.

### Inventive Example 7

A battery cell (lithium secondary battery) was produced in substantially the same manner as in Inventive Example 5 except that the weight (mg) of the electrolytic solution was 2.5 times the weight (mg) of the polythiophene. Then, evaluations were made in the same manner as in Inventive Example 5. The results are shown below in Table 2.

### Inventive Example 8

A battery cell (lithium secondary battery) was produced in substantially the same manner as in Inventive Example 5 except that the weight (mg) of the electrolytic solution was 1.5 times the weight (mg) of the polythiophene. Then, evaluations were made in the same manner as in Inventive Example 5. The results are shown below in Table 2.

### Comparative Example 5

A battery cell (lithium secondary battery) was produced in substantially the same manner as in Inventive Example 5 except that a solution mixture of 0.13 g of a styrene-butadiene rubber (SBR) emulsion (TRD2001 available from JSR Corporation and having an SBR content of 48% by weight) and 0.75 g of a poly (N-vinylpyrrolidone) aqueous solution (K-90W available from Nippon Shokubai Co., Ltd. and having a content of 19.8% by weight) was used instead of 8.11 g of the 4.5% by weight poly (acrylic acid-lithium) aqueous solution. In this composite sheet, a positive electrode active substance layer had a thickness of 195 μm and a void percentage of 45%. Then, evaluations were made in the same manner as in Inventive Example 5. The results are shown below in Table 2.

### Comparative Example 6

A battery cell (lithium secondary battery) was produced in substantially the same manner as in Comparative Example 5 except that the weight (mg) of the electrolytic solution was 3.5 times the weight (mg) of the polythiophene. Then, evaluations were made in the same manner as in Inventive Example 5. The results are shown below in Table 2.

### Comparative Example 7

A battery cell (lithium secondary battery) was produced in substantially the same manner as in Comparative Example 5 except that the weight (mg) of the electrolytic solution was 2.5 times the weight (mg) of the polythiophene. Then, evaluations were made in the same manner as in Inventive Example 5. The results are shown below in Table 2.

### Comparative Example 8

A battery cell (lithium secondary battery) was produced in substantially the same manner as in Comparative Example 5 except that the weight (mg) of the electrolytic solution was 1.5 times the weight (mg) of the polythiophene. Then, evaluations were made in the same manner as in Inventive Example 5. The results are shown below in Table 2.

TABLE 2

| | | | | Capacity |
|---|---|---|---|---|
| | | | | density per |
| | | Ratio of | Capacity | total weight of |
| | | electrolytic | density per | poly- |
| | Use of | solution | poly- | thiophene and |
| | poly- | weight/poly- | thiophene | electrolytic |
| | acrylic | thiophene | weight | solution |
| | acid (B) | weight (mg/mg) | (mAh/g) | (mAh/g) |
| Inv. | Yes | 4.5 | 25.0 | 4.5 |
| Ex. 5 | | | | |
| Inv. | Yes | 3.5 | 24.0 | 5.3 |
| Ex. 6 | | | | |
| Inv. | Yes | 2.5 | 23.0 | 6.6 |
| Ex. 7 | | | | |
| Inv. | Yes | 1.5 | 19.0 | 7.6 |
| Ex. 8 | | | | |
| Comp. | No | 4.5 | 19.0 | 3.5 |
| Ex. 5 | | | | |
| Comp. | No | 3.5 | 15.0 | 3.3 |
| Ex. 6 | | | | |
| Comp. | No | 2.5 | 12.0 | 3.4 |
| Ex. 7 | | | | |
| Comp. | No | 1.5 | 7.0 | 2.8 |
| Ex. 8 | | | | |

* An SBR/polyvinylpyrrolidone-based binder was used instead of the polyacrylic acid (B) in Comparative Examples 5 to 8.

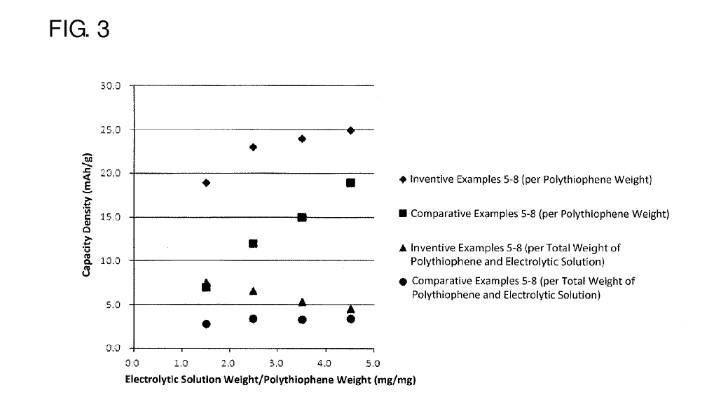

A relationship between the proportion of the electrolytic solution weight to the PEDOT weight and the capacity density (mAh/g) per total weight of the PEDOT and the electrolytic solution was shown in FIG. 2 for the battery cells (lithium secondary batteries) of Inventive Examples 1 to 4 and Comparative Examples 1 to 4 in which the proportion was varied as shown in Table 1. In addition, a relationship between the proportion and the capacity density (mAh/g) per PEDOT weight was also shown in FIG. 2. In FIG. 2, the abscissa represented the electrolytic solution weight/PEDOT weight (mg/mg), and the ordinate represented the capacity density (mAh/g) per PEDOT weight or per total weight of the PEDOT and the electrolytic solution. Similar data (Inventive Examples 5 to 8 and Comparative Examples 5 to 8) for the polythiophene-based material as shown in Table 2 were shown in FIG. 3.

The results of Table 1 and FIG. 2 show that, as a result of comparison between Inventive Examples 1 to 4 and Comparative Examples 1 to 4 which have the same proportion of the electrolytic solution weight to the PEDOT weight, the products of Inventive Examples 1 to 4 which use the PEDOT (A) and the polyacrylic acid (B) have markedly higher capacity density values per PEDOT weight and per total weight of the PEDOT and the electrolytic solution than the products of Comparative Examples 1 to 4 which do not use the polyacrylic acid (B). It is also found that, as the proportion of the electrolytic solution weight to the PEDOT weight decreases (that is, as the PEDOT weight increases), the capacity density per PEDOT weight decreases in the products of Inventive Examples 1 to 4 and Comparative Examples 1 to 4, but the degree of the decrease is greater in the products of Comparative Examples 1 to 4. Further, it is found that, as the proportion of the electrolytic solution weight to the PEDOT weight decreases (that is, as the PEDOT weight increases), the capacity density per total weight of the PEDOT and the electrolytic solution increases in the products of Inventive Examples 1 to 4 and Comparative Examples 1 to 4, but the degree of the increase is greater in the products of Inventive Examples 1 to 4.

It is therefore found from Table 1 and FIG. 2 that the products of Inventive Examples 1 to 4 which use (A) and (B) of the present invention have a higher capacity density than the products of Comparative Examples 1 to 4 which does not use polyacrylic acid serving as (B) but use SBR to thereby have an especially excellent effect. As to such an effect, it is also apparent from the results of Table 2 and FIG. 3 that the polythiophene-based material in Inventive Examples 5 to 8 and Comparative Examples 5 to 8 has tendencies similar to those of the aforementioned PEDOT-based material.

While specific forms of the embodiment of the present invention have been shown in the aforementioned inventive examples, the inventive examples are merely illustrative of the invention but not limitative of the invention. It is contemplated that various modifications apparent to those skilled in the art could be made within the scope of the invention.

The power storage device according to the present invention is advantageously used as a power storage device for a lithium secondary battery and the like. The power storage device according to the present invention can be used for the same applications as the prior art secondary batteries, for example, for mobile electronic apparatuses such as mobile PCs, mobile phones and personal data assistants (PDAs), and for driving power sources for hybrid electric cars, electric cars and fuel battery cars.

### REFERENCE SIGNS LIST

1 Current collector (for positive electrode)
2 Positive electrode
3 Electrolyte layer
4 Negative electrode
5 Current collector (for negative electrode)

1. A power storage device comprising an electrolyte layer, and a positive electrode and a negative electrode provided, with the electrolyte layer interposed therebetween,
wherein at least one of the electrodes is a composite including at least a thiophene polymer (A) having electrical conductivity varied by ion insertion/desertion, and a polycarboxylic acid (B), and
wherein the polycarboxylic acid (B) is fixed in the electrode.

2. The power storage device according to claim 1, wherein the thiophene polymer is subjected to an alkali treatment and/or a reduction treatment.

3. An electrode for a power storage device, the electrode being a composite including at least a thiophene polymer (A) having electrical conductivity varied by ion insertion/desertion, and a polycarboxylic acid (B),
wherein the polycarboxylic acid (B) is fixed in the electrode.

4. The electrode for a power storage device according to claim 3, wherein the thiophene polymer is subjected to an alkali treatment and/or a reduction treatment.

5. A porous sheet for a power storage device electrode, comprising a composite including at least a thiophene polymer (A) having electrical conductivity varied by ion insertion/desertion, and a polycarboxylic acid (B),
wherein the polycarboxylic acid (B) is fixed in the electrode.

6. The porous sheet for a power storage device electrode according to claim 5, wherein the thiophene polymer is subjected to an alkali treatment and/or a reduction treatment.
